(19) United States
(12) Patent Application Publication
(10) Pub. No.: US 2016/0335612 A1
(43) Pub. Date: Nov. 17, 2016

(54) Method of Selling Media Based on Individual Consumption

(71) Applicant: Patrick Quinn Sweeney, Chicago, IL (US)

(72) Inventor: Patrick Quinn Sweeney, Chicago, IL (US)

(21) Appl. No.: 15/152,421

(22) Filed: May 11, 2016

Related U.S. Application Data
(60) Provisional application No. 62/159,796, filed on May 11, 2015.

(51) Int. Cl. G06Q 20/10

(52) U.S. Cl. CPC G06Q 20/10

(57) ABSTRACT

A method of selling media based on individual consumption is used to charge users for viewing or listening to content based on how much of the content is consumed. The method of the present invention is performed by a system in which at least one remote server is used to store a plurality of content files and manage a plurality of user accounts. A desired file from the plurality of content files may be streamed to a corresponding computing device for an arbitrary account from the plurality of user accounts. As the desired file is streamed, a quantifiable content consumption is measured for the desired file. The quantifiable content consumption is compared to the desired file to calculate an adjustment proportion. The adjustment proportion is applied to a total price of the desired file in order to charge the arbitrary account based on the amount of content consumed.

The current application claims benefit of U.S. Provisional Patent application Ser. No. 62/159,796 filed on May 11, 2015.

### FIELD OF THE INVENTION

The present invention relates generally to methods for selling audiovisual media. More specifically, the present invention is a method for selling media content to users based on the consumption of said media by each individual user.

### BACKGROUND OF THE INVENTION

Various forms of audiovisual content, including movies, concert performances, and educational lessons are widely available on the web but are often only available to customers who are willing to prepay for the content. Unfortunately, this can lead to users purchasing an entire concert, show, etc. only to later find that the wrong content was purchased or the content does not meet expectations. This can also lead to difficulties for new artists to sell art because users may not wish to gamble on purchasing content that they may not like.

Accordingly, there is a present need for a method of providing audiovisual content to users so that the user is only charged based on the amount of content the user consumes. The present invention is used to stream content files to a user's computing device and track the amount of content that the user watches or listens to. The content may be tracked based on the amount of time spent consuming the content, or the amount of data used to consume the content. As a result, users are able to consume portions of content without being charged for the entire content file.

### BRIEF DESCRIPTION OF THE DRAWINGS

FIG. 1 is a schematic diagram of the present invention.

FIG. 2 is a schematic diagram of the present invention.

FIG. 3 is a flowchart describing the general process of the present invention.

FIG. 4 is a flowchart describing the preferred embodiment of the present invention, wherein the preferred embodiment uses consumed intervals to determine the quantifiable content consumption.

FIG. 5 is a flowchart describing the second embodiment of the present invention, wherein the second embodiment uses the consumed duration to determine the quantifiable content consumption.

FIG. 6 is a flowchart describing the third embodiment of the present invention, wherein the preferred embodiment uses the data size to determine the quantifiable content consumption.

FIG. 7 is a flowchart describing the process of providing the plurality of content files.

FIG. 8 is a flowchart describing the process of receiving the payment to satisfy the consumption content price.

FIG. 9 is a flowchart describing the processes of providing content files and streaming the desired file with the live-streaming device.

### DETAILED DESCRIPTION OF THE INVENTION

All illustrations of the drawings are for the purpose of describing selected versions of the present invention and are not intended to limit the scope of the present invention.

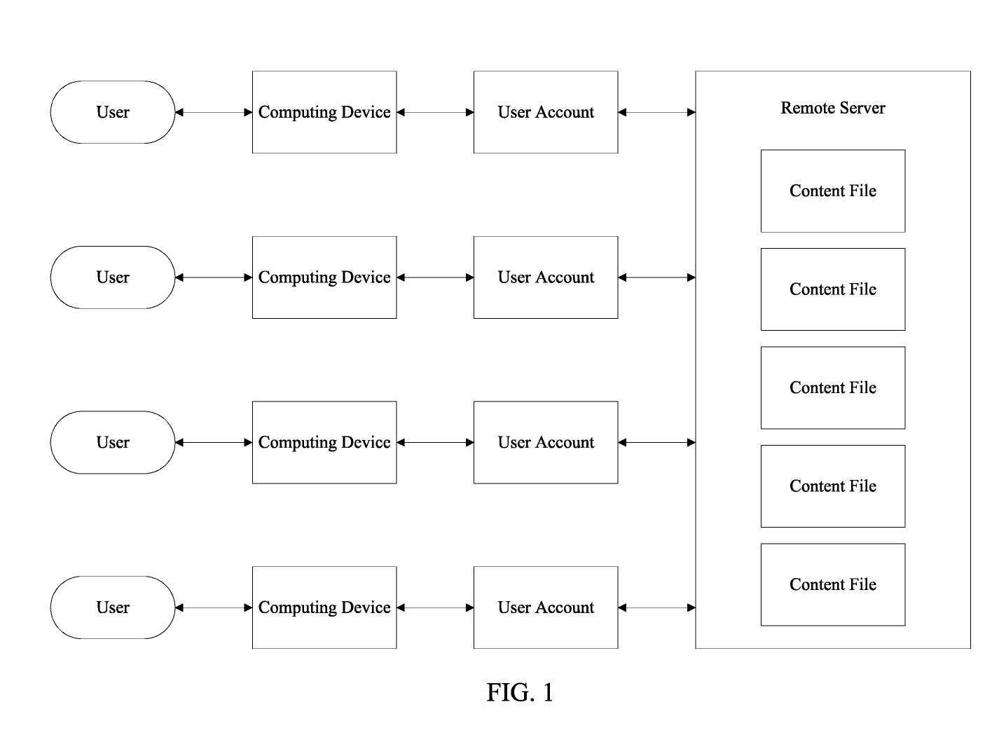

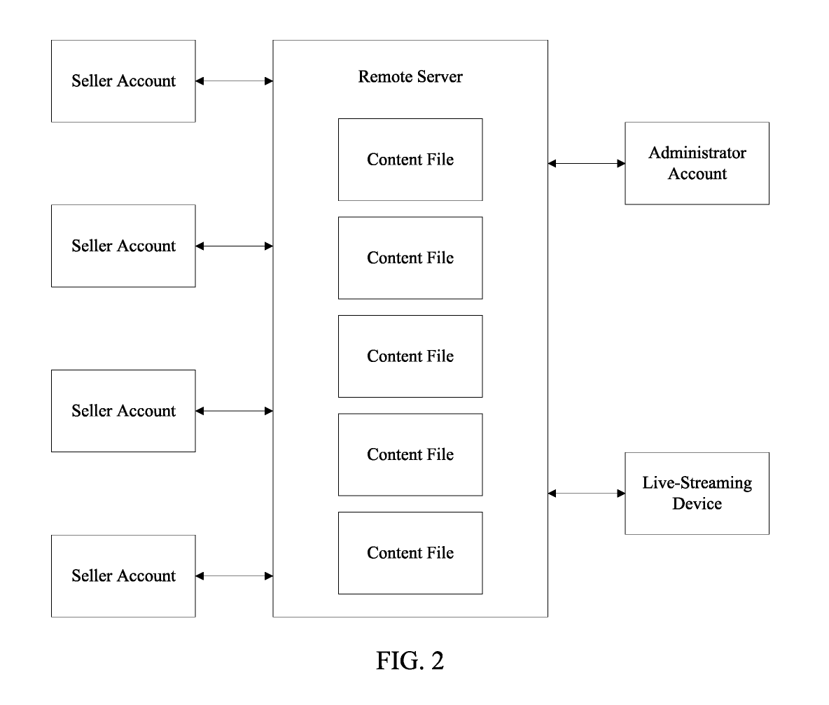

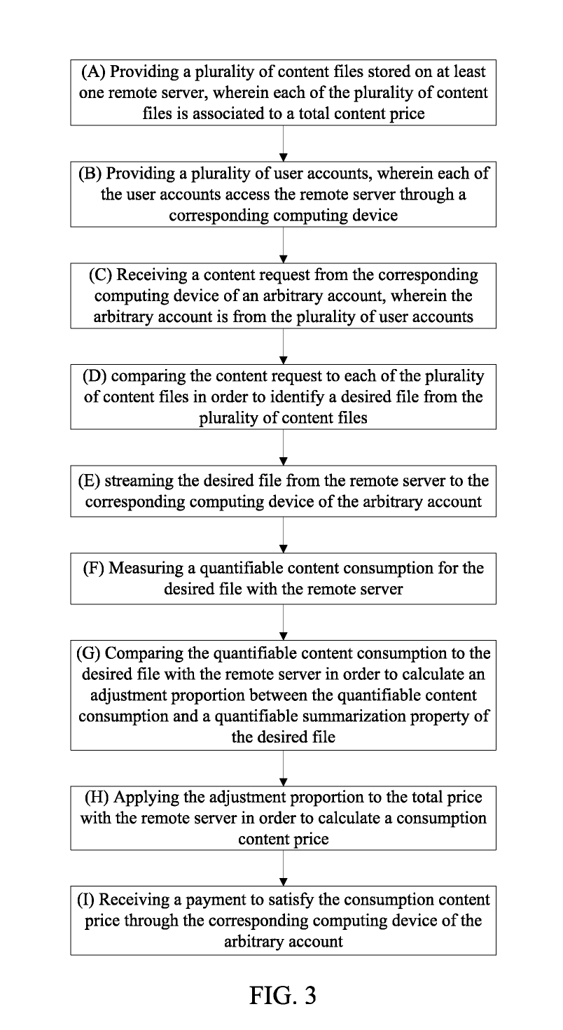

With reference to FIGS. 1-3, the present invention is a method of selling media content based on individual consumption. The present invention is designed to charge users to view, listen to, or otherwise consume media based on the amount of media which is consumed. The present invention allows users to skip to certain songs of a concert, scenes in a movie, or other sections of media files, without having to pay for viewing or listening to the entire concert or movie. Moreover, if a user does not enjoy a particular content file, the user is able to stop viewing or listening to the content file without needing to pay for consuming the entire content file. The method of the present invention is performed by a system. In the system of the present invention, a plurality of content files is stored on an at least one remote server, wherein each of the plurality of content files is associated to a total content price (Step A). Each of the content files contains some form of audio and/or visual media which can be accessed by a number of users. The total content price corresponds to the price of viewing or listening to the entirety of the content file. A plurality of user accounts is managed by the remote server, wherein each of the user accounts allows a user to access the remote server and therefore the plurality of content files through a corresponding computing device (Step B). To do so, a content request from the corresponding computing device of an arbitrary account is received by the remote server, wherein the arbitrary account is from the plurality of user accounts (Step C). The arbitrary account represents any one of the plurality of user accounts.

The content request acts as an attempt to access a desired file. The content request is compared to each of the plurality of content files in order to identify the desired file from the plurality of content files (Step D). As content requests may vary by user, the desired file varies accordingly. Once the desired file is identified, the desired file is streamed from the remote server to the corresponding computing device of the arbitrary account (Step E). In order to ultimately determine how much a user is to be charged, a quantifiable content consumption is measured for the desired file with the remote server (Step F). The quantifiable content consumption is used to measure how much of the desired file is consumed by the user. The quantifiable content consumption is compared to the desired file with the remote server in order to calculate an adjustment proportion between the quantifiable content consumption and a quantifiable summarization property of the desired file (Step G). The quantifiable summarization property is used to reflect the total length of the desired file. This metric may be based on time viewed, amount of data streamed, or some other means. The adjustment proportion is used to determine what the user is to be charged based on how much of the desired file is consumed. For example, if the user consumes half of the desired file, the adjustment proportion would be used to charge the user half of the total content price.

Accordingly, t he adjustment proportion is applied to the total price with the remote server in order to calculate a consumption content price (Step H). The consumption content price is a monetary amount that reflects what portion of the desired file is consumed by the user. If the user views or listens to the entire desired file, the consumption content price equals the total content price. Further, if the user skips through portions of the desired file, the consumption content price is less than the total content price. The opposite may be true if the user decides to replay portions of the desired file. Once the user is finished watching or listening to the desired file, a payment is received to satisfy the consumption content price through the corresponding computing device of the arbitrary account (Step I).

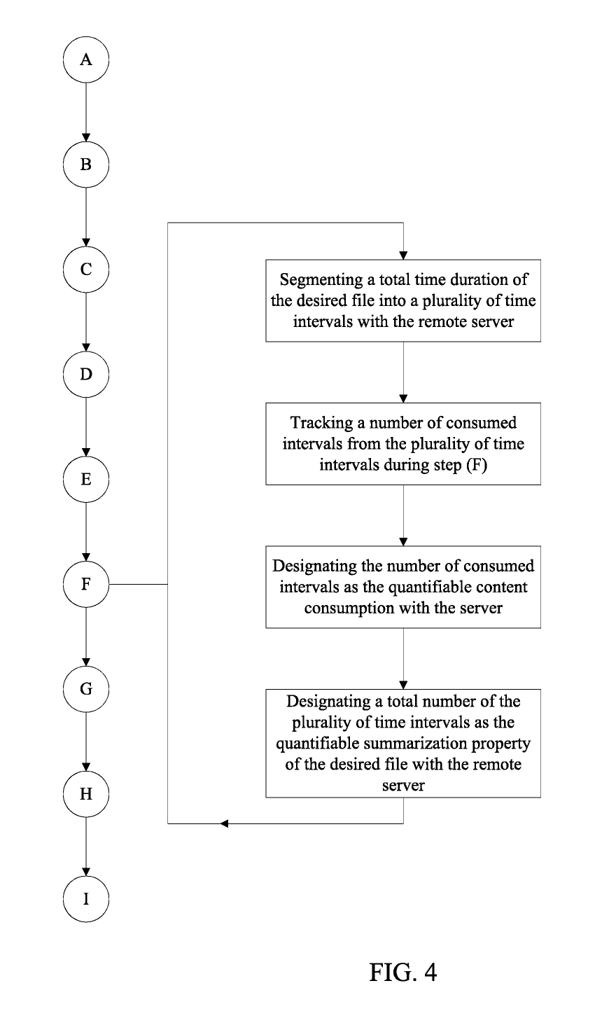

In the preferred embodiment of the present invention, a total time duration of the desired file is segmented into a plurality of time intervals with the remote server. In reference to FIG. 4, each of the plurality of time intervals is used to indicate different portions of the desired file. A number of consumed intervals from the plurality of time intervals is tracked during Step F. The number of consumed intervals indicates to how much of the desired file the user watched or listened to. The number of consumed intervals is designated as the quantifiable content consumption using the remote server. This is done so that the user is charged only for the length of the desired file which is consumed. The remote server is also used to designate a total number of the plurality of time intervals as the quantifiable summarization property of the desired file. As a result, the adjustment proportion may be calculated based on the relationship between number of consumed intervals and the total number of the plurality of intervals.

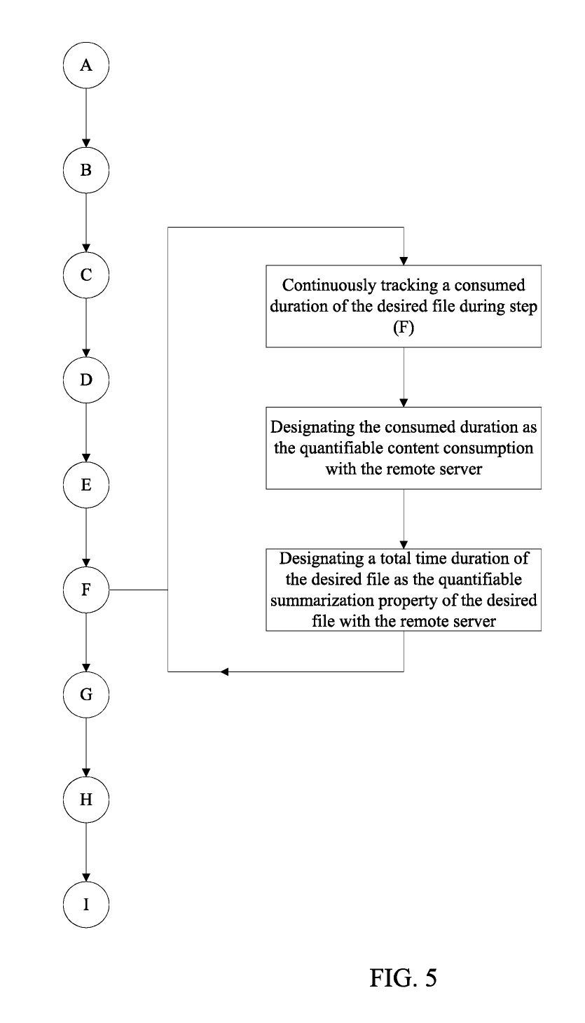

In a second embodiment of the present invention, shown in FIG. 5, a consumed duration of the desired file is continuously tracked during Step F. The second embodiment differs from the first embodiment because the second embodiment tracks specific lengths of time rather than segments of time. This allows the user to be charged more accurately. In the second embodiment of the present invention, the consumed duration is designated as the quantifiable content consumption with the remote server. Further, the remote server is used to designate a total time duration of the desired file as the quantifiable summarization property of the desired file. As a result, the adjustment proportion may be calculated based on the exact time spent watching or listening to the desired file relative to the exact length of the desired file. The consumed duration and the total duration may be tracked in seconds, milliseconds, or even more precise measurements.

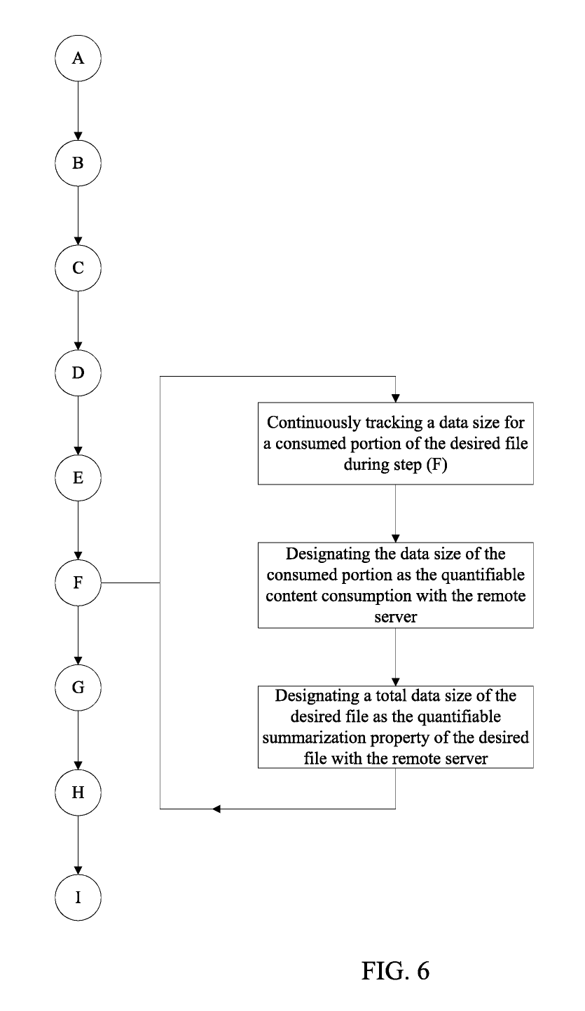

In a third embodiment of the present invention, shown in FIG. 6, a data size for the consumed portion of the desired file is continuously tracked during Step F. Here, data is used in a similar manner to time in order to determine how much of the desired file is consumed. The remote server is used to designate the data size of the consumed portion as the quantifiable content consumption. A total data size of the desired file is designated as the quantifiable summarization property of the desired file using the remote server. By measuring the desired file in this way, the adjustment proportion may be calculated based on the relationship between the amount of data consumed and the amount of data that makes up the desired file.

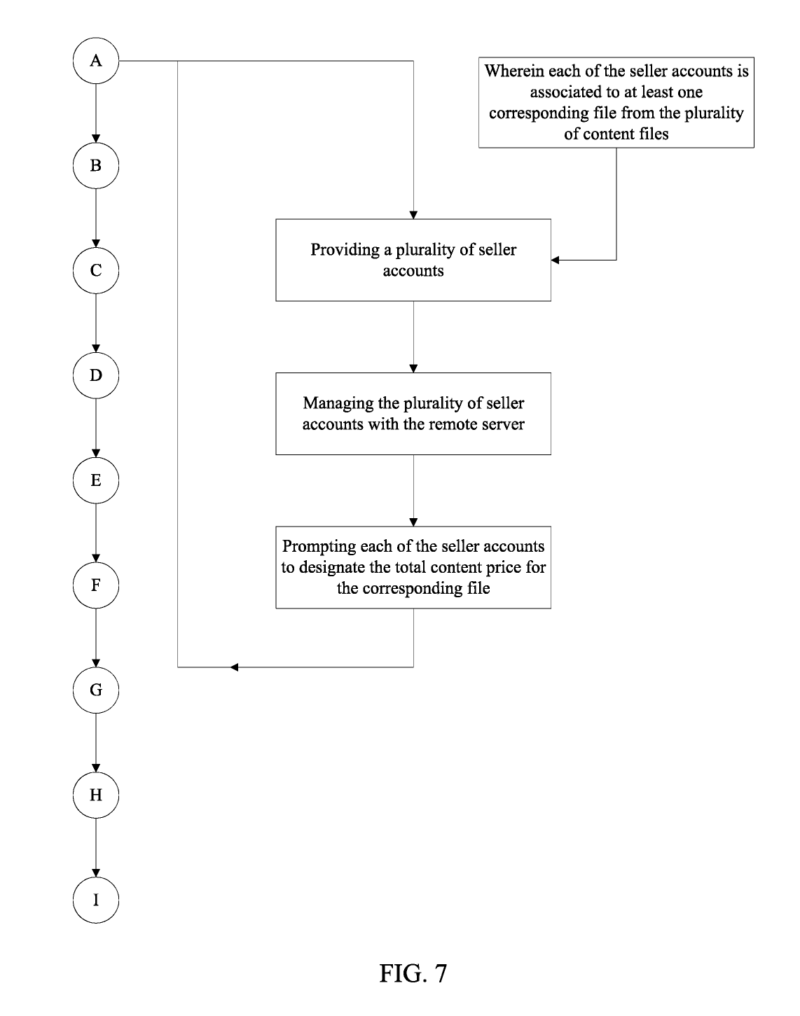

In order to make the plurality of content files available, a plurality of seller accounts is provided. In reference to FIG. 7, each of the seller accounts is managed with the remote server and is associated to at least one corresponding file from the plurality of content files. The plurality of seller accounts is used to upload content files to the remote server accept payments. As an example, a seller account may be made by a band to profit on music or performance videos using the present invention. Each of the seller accounts is prompted to designate the total content price for the corresponding file. This not only allows sellers to specifically set the price of their content but also analyze whether the content price fits what consumers are willing to pay for content.

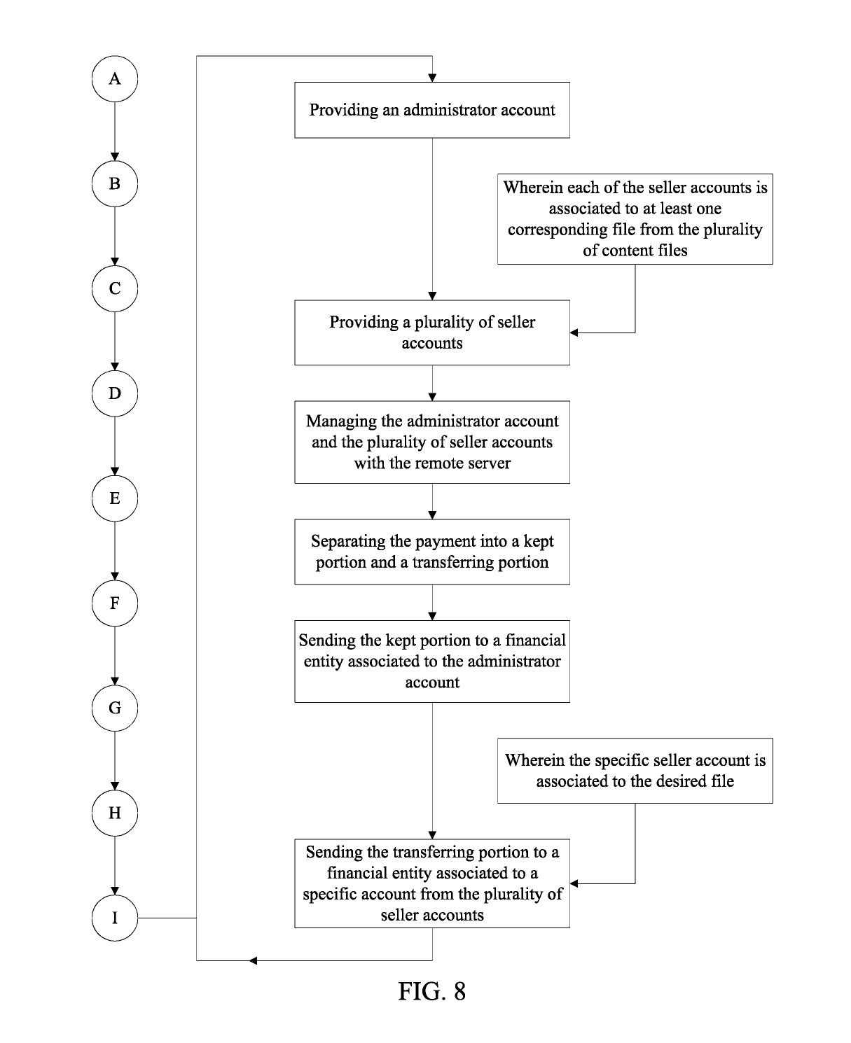

In reference to FIG. 8, an administrator account is also provided and managed by the remote server. The administrator account is used to control various features of the present invention and monitor the consumption of the plurality of content files. When the payment is received for the desired file, the payment is separated into a kept portion and a transferring portion. By using the present invention, seller accounts would likely agree to split a portion of any profits with the administrator account. Accordingly, the kept portion is sent to a financial entity associated with the administrator account. The transferrable portion is sent to a financial entity associated to a specific seller account from the plurality of seller accounts, wherein he specific seller account is associated to the desired file. The payment may be further split in alternative embodiments of the present invention as needed. This feature could be used to pay for content files with shared ownership or to donate earnings to charities.

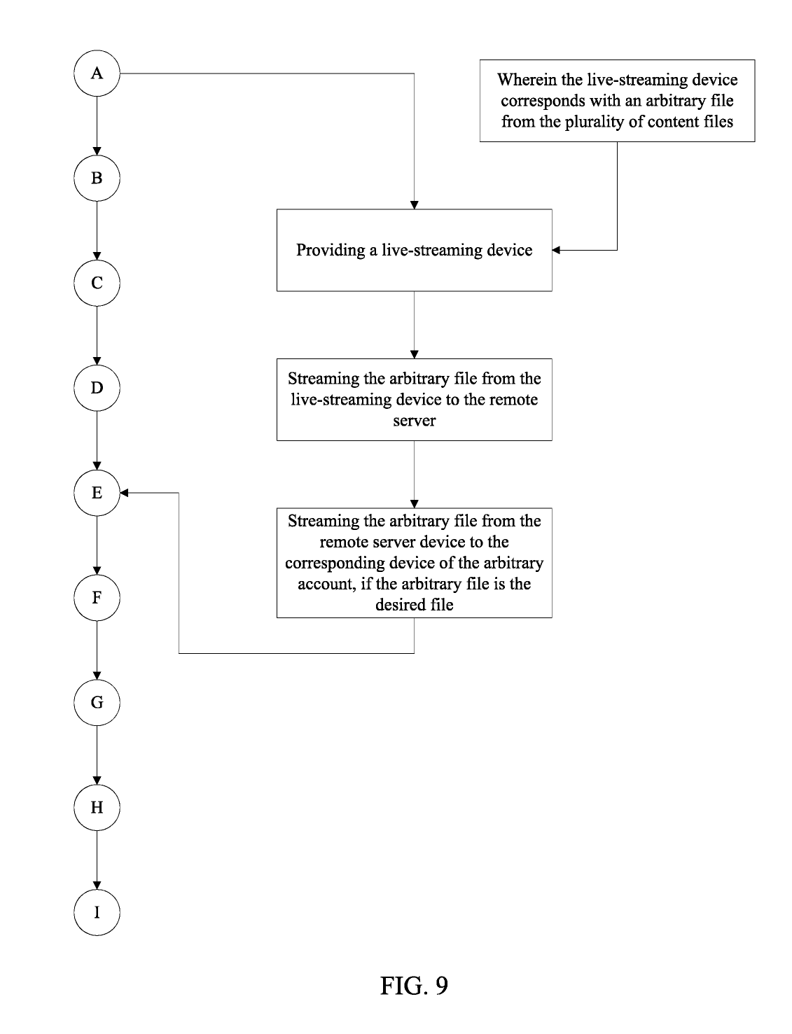

In addition to saved content, the present invention may be used for live events. For such situations, a live-streaming device is provided. In reference to FIG. 9, the live-streaming device corresponds with an arbitrary file from the plurality of content files. Live-streaming devices can include, but are not limited to, smartphones, cameras, and computers. As an event is occurring, the arbitrary file is streamed from the live-streaming device to the remote server. This allows the event to be streamed live or saved for later consumption. The arbitrary file is then streamed from the remote server to the corresponding device of the arbitrary account if the arbitrary file is desired file.

Although the invention has been explained in relation to its preferred embodiment, it is to be understood that many other possible modifications and variations can be made without departing from the spirit and scope of the invention as hereinafter claimed.

What is claimed is:

1. A method of selling media based on individual consumption, the method comprises the steps of:
(A) providing a plurality of content files stored on at least one remote server, wherein each of the plurality of content files is associated to a total content price;
(B) providing a plurality of user accounts, wherein each of the user accounts access the remote server through a corresponding computing device;
(C) receiving a content request from the corresponding computing device of an arbitrary account, wherein the arbitrary account is from the plurality of user accounts;
(D) comparing the content request to each of the plurality of content files in order to identify a desired file from the plurality of content files;
(E) streaming the desired file from the remote server to the corresponding computing device of the arbitrary account;
(F) measuring a quantifiable content consumption for the desired file with the remote server;
(G) comparing the quantifiable content consumption to the desired file with the remote server in order to calculate an adjustment proportion between the quantifiable content consumption and a quantifiable summarization property of the desired file;
(H) applying the adjustment proportion to the total price with the remote server in order to calculate a consumption content price; and
(I) receiving a payment to satisfy the consumption content price through the corresponding computing device of the arbitrary account.

2. The method of selling media based on individual consumption as claimed in claim 1 comprises:
segmenting a total time duration of the desired file into a plurality of time intervals with the remote server;
tracking a number of consumed intervals from the plurality of time intervals during step (F);
designating the number of consumed intervals as the quantifiable content consumption with the remote server; and
designating a total number of the plurality of time intervals as the quantifiable summarization property of the desired file with the remote server.

3. The method of selling media based on individual consumption as claimed in claim 1 comprises:
continuously tracking a consumed duration of the desired file during step (F);
designating the consumed duration as the quantifiable content consumption with the remote server; and
designating a total time duration of the desired file as the quantifiable summarization property of the desired file with the remote server.

4. The method of selling media based on individual consumption as claimed in claim 1 comprises:
continuously tracking a data size for a consumed portion of the desired file during step (F);
designating the data size of the consumed portion as the quantifiable content consumption with the remote server; and
designating a total data size of the desired file as the quantifiable summarization property of the desired file with the remote server.

5. The method of selling media based on individual consumption as claimed in claim 1 comprises:
providing a plurality of seller accounts, wherein each of the seller accounts is associated to at least one corresponding file from the plurality of content files;
managing the plurality of seller accounts with the remote server; and
prompting each of the seller accounts to designate the total content price for the corresponding file.

6. The method of selling media based on individual consumption as claimed in claim 1 comprises:
providing an administrator account;
providing a plurality of seller accounts, wherein each of the seller accounts is associated to at least one corresponding file from the plurality of content files;
managing the administrator account and the plurality of seller accounts with the remote server;
separating the payment into a kept portion and a transferring portion;
sending the kept portion to a financial entity associated to the administrator account; and
sending the transferrable portion to a financial entity associated to a specific seller account from the plurality of seller accounts, wherein the specific seller account is associated to the desired file.

7. The method of selling media based on individual consumption as claimed in claim 1 comprises:
providing a live-streaming device, wherein the live-streaming device corresponds with an arbitrary file from the plurality of content files;
streaming the arbitrary file from the live-streaming device to the remote server; and
streaming the arbitrary file from the remote server to the corresponding device of the arbitrary account,
if the arbitrary file is the desired file.
